(19) United States
(12) Patent Application Publication
(10) Pub. No.: US 2003/0033430 A1
(43) Pub. Date: Feb. 13, 2003

(54) IP flow discovery for IP probe auto-configuration and SLA monitoring

(76) Inventors: Chi Leung Lau, Morganville, NJ (US); Bruce Siegell, Shrewsbury, NJ (US)

Correspondence Address: Joseph Giordano, Esq., Telcordia Technologies, Inc., 445 South Street, Morristown, NJ, 07960, US

(21) Appl. No.: 09/909,645

(22) Filed: Jul. 20, 2001

(51) Int. Cl. G06F 15/173; G06F 15/16

(52) U.S. Cl. 709/245

(57) ABSTRACT

Methods and systems are provided for identifying the flow of data between a source and destination in a network. A pair of flow monitors may identify a plurality of data packets flowing between a pair of measuring points in a network. The flow monitors may then compare address information of each identified data packet. When the flow monitors identify matching addresses through the comparison, the addresses of the corresponding data packets are associated with the flow between the measuring points. Once the flow between the pair of measuring points is identified, the flow monitors may compare the header information of the data packets associated with the flow to determine the direction of the flow between the measuring points.

### BACKGROUND OF THE INVENTION

The present invention relates generally to network monitoring, and more particularly, to a method and system for Internet Protocol flow discovery for a Multi-network configuration.

Communications systems, such as packet networks, are used in various applications for transporting data from one user site to another. At a transmission site in a packet network, data is typically partitioned into one or more packets each of which includes a header containing routing and other information relating to the data. The network then transports the packets to a destination site in accordance with any of several conventional protocols known in the art, such as Asynchronous Transfer Mode (ATM), Frame Relay (FR), High Level Data Link Control (HDLC), X.25, Internet Protocol (IP), etc. At the destination site, the data is restored from the packets received from the transmission site.

The nature of packet switched technology, however, complicates the ability of an Information Technology (IT) manager of an end-user network to monitor the performance of a wide area network (WAN) service provider. The WAN service provider administers a WAN used for transporting data packets originating from customer premises equipment (CPE) in the end-user network across the WAN. Both the customer and the network service provider have an interest in monitoring the performance of the WAN to verify that the performance conforms with the quality of service “guaranteed” by the WAN service provider.

For example, one type of end-user network is an Internet Protocol (IP) Virtual Private Network (VPN). A VPN includes a set of Virtual Private Links (VPLs), each of which includes a communication channel between two customer networks.

Network performance guarantees have emerged as a means for IT managers to ensure that their critical businesses data is delivered in a reliable, consistent manner. The term Service Level Agreements (SLA) refers to these performance guarantees. Common SLA parameters (or metrics) include packet throughput, packet loss ratio (PLR), packet delay, packet jitter, and service availability.

The primary objective of any service provider is to provide a quality service to its customers. Achieving a desired level of quality is not an easy task in light of the complexity of existing network environments. A network environment includes different types of equipment with different types of statistics for measuring performance, making difficult the measurement and correlation of end-to-end statistics.

Existing SLA monitoring devices monitor and collect statistics for an ISP when the end points of the network are known. These monitoring devices are configured manually and are usually no more than one network apart.

A disadvantage of these devices is realized when the end points of the network is not known, causing insufficient or improper configuration of the monitoring devices. A second disadvantage is realized when the end points of the networks are more than one ISP away, making difficult the task of determining end points. A third disadvantage is even if the end point addresses are known to the ISP, the manual configuration of the end point addresses into the existing monitors will be tedious and impractical due to its large volume.

### SUMMARY OF THE INVENTION

To overcome the above and other disadvantages of the prior art, methods and systems are provided for identifying a flow between a source and a destination in a network.

In one embodiment, a flow of data between a source and a destination in a network is determined based on a plurality of data packets identified at a first and second measuring point in the network. A destination address of each packet identified at the first point is compared with one or more destination addresses of packets identified at the second point. When the address comparison produces a match, a source address corresponding to the packet identified at the first point is identified. The identified source address and the matching destination addresses are then associated with a flow between the source and destination.

In another embodiment, the direction of flow of data between a source and a destination in a network is determined. A plurality of packets at a first and second point in the network is identified and a time-to-live value of the plurality of packets identified at the first or second point is selected. Further, the destination address of each packet identified at the first point is compared with the destination address of one or more packets identified at the second point. When the address comparison produces a match, a source address corresponding to the packet identified at the first point is identified. The identified source address and the matching destination address are then associated with a flow between the source and destination. The time-to-live value of the packets identified at the first point is compared with the time-to-live of at least one of the plurality of packets identified at the second point corresponding to the flow between the source and destination. Based on the comparison of time-to-live values the direction of flow between the source and destination is determined.

In yet another embodiment, a source address of each packet identified at the second point is compared with one or more source addresses of packets identified at the first point. When the address comparison produces a match, a destination address corresponding to the packet identified at the second point is identified. The identified source address and the matching destination addresses are then associated with a flow between the source and destination.

The description of the invention and the following description for carrying out the best mode of the invention should not restrict the scope of the claimed invention. Both provide examples and explanations to enable others to practice the invention. The accompanying drawings, which form part of the description for carrying out the best mode of the invention, show several embodiments of the invention, and together with the description, explain the principles of the invention.

### BRIEF DESCRIPTION OF THE DRAWINGS

FIG. 1 is a block diagram of a network, in accordance with methods and systems consistent with the present invention;

FIGS. 2-3 are block diagrams of flow monitors, in accordance with methods and systems consistent with the present invention;

FIG. 4 is a flow chart of the steps for identifying a flow between a source and a destination when destination addresses are collected, in accordance with methods and systems consistent with the present invention;

FIG. 5 is a flow chart of the steps for compressing network addresses, in accordance with methods and systems consistent with the present invention;

FIG. 6 is a flow chart of the steps for determining the direction of a flow between a source and a destination, in accordance with methods and systems consistent with the present invention;

FIG. 7 is a flow chart of the steps for determining additional networks corresponding to data packets that flow between a source and destination in accordance with methods and systems consistent with the present invention;

FIG. 8 is a flow chart of the steps for identifying a flow between a source and a destination when source addresses are collected, in accordance with methods and systems consistent with the present invention.

### DETAILED DESCRIPTION OF THE EMBODIMENTS

Reference will now be made in detail an implementation of the invention, an example of which is illustrated in the accompanying drawings. Wherever possible, the same reference numbers will be used throughout the drawings to refer to the same or like parts.

In accordance with an embodiment of the invention, methods and systems are provided to identify the flow data packets between two measuring points in a network and determine the direction of the flow of data between those same two measuring points. Using a flow monitor located at each measuring point, address and header information of data packets flowing through the two measuring points are stored. The address and header information is communicated between the measuring points and processed to identify the data flowing between the two measuring points. Further computations are performed to determine the direction of the flow of data packets.

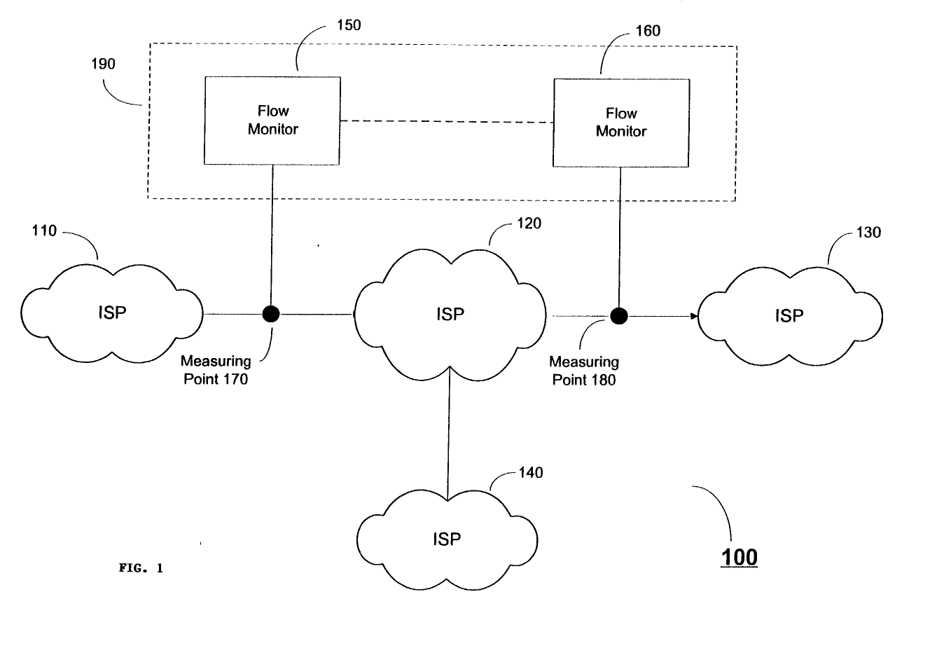

FIG. 1 is a block diagram illustrating a network 100, in accordance with an embodiment of the present invention. Network 100 comprises Internet service providers (ISPs) 110, 120, 130, and 140, measuring points 170 and 180, and system 190. ISPs 110, 120,130, and 140 allow communication devices to transfer data over the network 100. For example, ISP 120 is a core network of network 100 that facilitates communication between ISPs 110, 130, and 140.

System 190 includes flow monitors 150 and 160, which extract addresses of data packets in the network at measuring points 170 and 180, respectively. A measuring point may also be located between ISP 120 and ISP 140, in accordance with an embodiment of the invention. A measurement point is the boundary between a host and an adjacent link at which performance reference events can be observed and measured. A source measurement point and a destination measurement point are two measurement points at which packet traffic is measured. The traffic measured flows between the source and destination measurement points, but may originate before the source measurement point and may terminate after the destination measurement point. Flow monitors 150 and 160 identify packets flowing through the respective measuring points by correlating source or destination addresses identified at each measuring point.

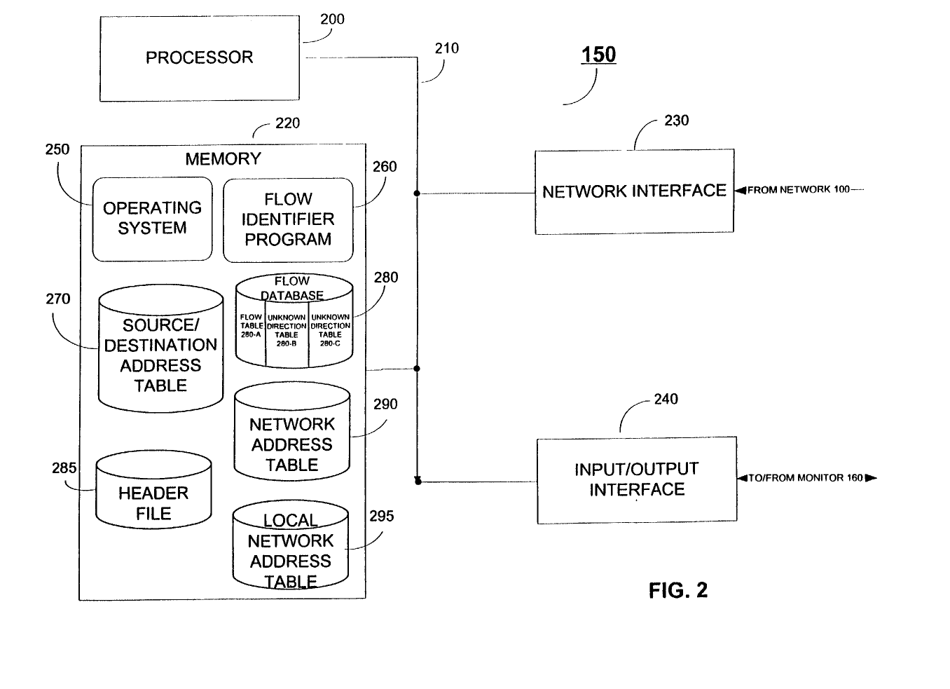

FIG. 2 is a block diagram of flow monitor 150, in accordance with an embodiment of the present invention. Flow monitor 150 may include a processor 200, a bus 210, a memory 220, a network interface 230, and an input/output module 240.

Memory 220 may include an operating system 250, a flow identifier program 260, a source/destination address table 270, a flow database 280, a header file 285, a network address table 290, and a local network address table 295. Operating system 250 may control all processing operations within flow monitor 150. Among other things, operating system 250 may schedule processing tasks, manage storage of information, and handle communication with other peripherals. The type of processing performed by operating system 250 may depend upon the type of addresses being monitored and the location of flow monitor 150 with respect to the flow of data packets.

Flow identifier program 260 may include code that processes identified data packets flowing, for example, through measuring point 170. Source/destination address table 270 may include either source or destination address information associated with data packets identified by flow identifier program 260. Flow monitor 150 may create a flow table in flow database 280 when flow monitor 150 receives an address table from flow monitor 160. For example, flow database 280 may include a number of separate flow tables, such as flow table 280-A, “unknown direction” table 280-B, and “unknown direction” table 280-C. Flow table 280-A may identify data packets having a known direction of flow. Unknown direction table 280-B may identify data packets having an unknown direction and selected by the flow monitor of interest. “Unknown direction” table 280-C may identify data packets having an unknown direction and selected by flow monitor 160. Flow database 280 may include source and destination addresses associated with the flow of data between measuring points 170 and 180. Flow identifier program 260 may use flow database 280 to identify only those packets that flow between measuring points 170 and 180. Header file 285 may store a time-to-live value extracted from the header information of identified data packets flowing through measuring point 170. The stored time-to-live value being associated with a source/destination address in source/destination table 270 extracted from header information of the same identified data packet.

Local network address table 295 may include the address of the network nearest to flow monitor 150. The addresses identified in local network address table 295 may correspond to source or destination addresses of an identified data packet.

Network address table 290 may include network information used during compression operations to reduce the amount of data communicated with flow monitor 160. Network address table 290 may include data packet addresses of the network nearest to flow monitor 160. The addresses of network address table 290 may correspond to source or destination addresses of an identified data packet. Particularly, flow monitors 150 and 160 may include a network address table for each flow monitor associated with another network (not shown).

Network interface module 230 receives data packet information of network 100 and stores this information in source/destination address table 270 via bus 210. Network interface module 230 may also facilitate communications between flow monitor 160 and other flow monitors (not shown) of network 100.

Input/Output interface module 240 may enable out-of-band communication between a pair of flow monitors or may be configured to connect other peripheral devices, such as a keyboard, a display unit, a printer, or the like.

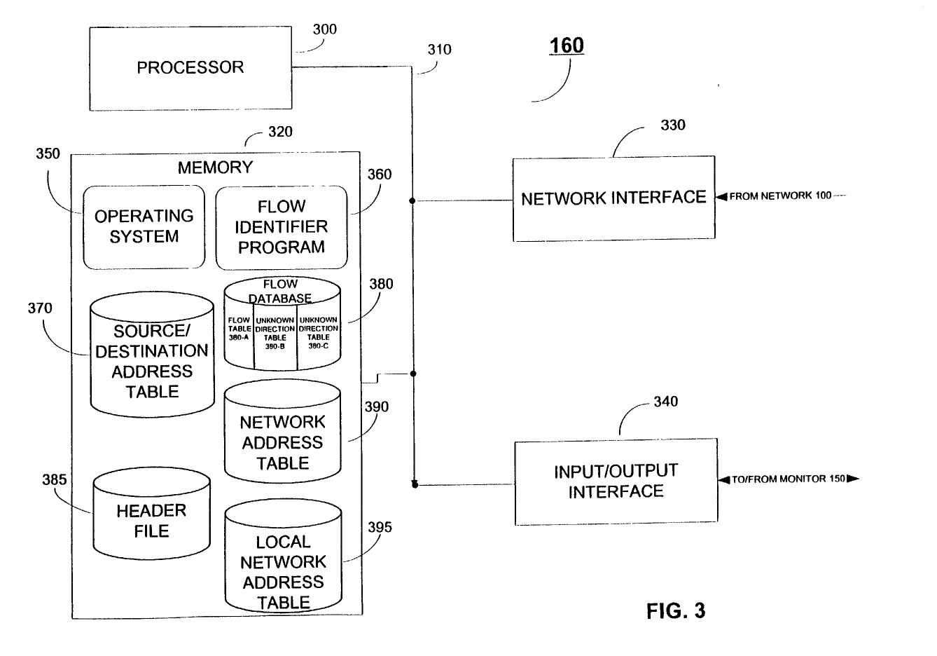

FIG. 3 is a block diagram of flow monitor 160, in accordance with an embodiment of the present invention. Flow monitor 160 may include a processor 300, a bus 310, a memory 320, a network interface 330, and an input/output module 340. Processor 300, bus 310, network interface 330, and input/output module 340 all may operate as described above with respect to the corresponding elements of flow monitor 150.

Memory 320 may include an operating system 350, a flow identifier program 360, a source/destination address table 370, a flow table 380, a header file 385, a network address table 390, and a local network address table 395. All of these elements may operate as described above with respect to the corresponding elements of flow monitor 150. The type of processing performed by operating system 350 may depend upon whether source or destination addresses are being monitored and the location of flow monitor 160 with respect to the flow of data packets.

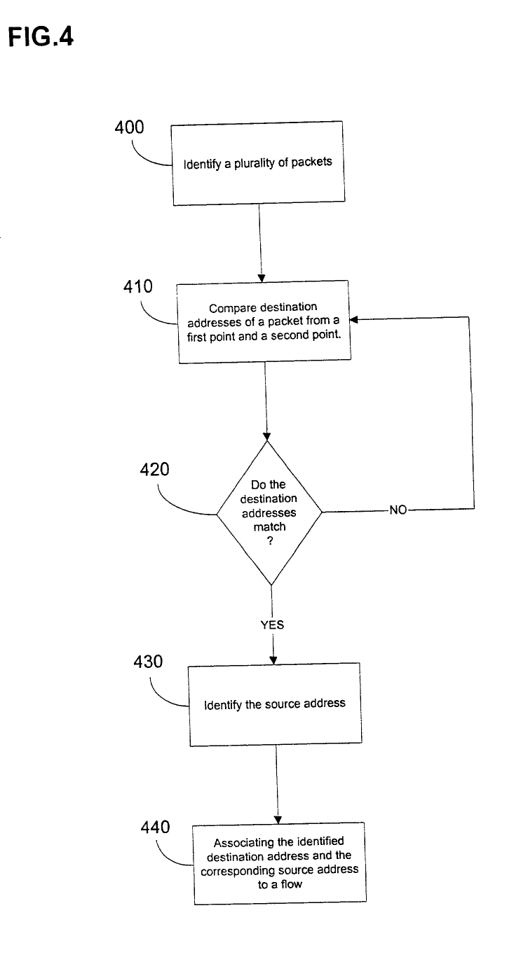

FIG. 4 is a flow chart of the steps performed by system 190 for identifying the flow of data packets between measuring points 170 and 180, in accordance with an embodiment of the invention. In this embodiment, direction of the flow of data packets to be monitored may originate at ISP 110 (source) or at an ISP (not shown) located upstream from ISP 110. Likewise, the flow of data packets of interest may terminate at ISP 130 (destination) or terminate at an ISP (not shown) located downstream from ISP 130. In this embodiment, the data packets to be monitored may originate or terminate at ISP 110, ISP 130, or ISP 140, respectively.

Flow identifier program 360 in flow monitor 160 identifies the destination addresses of data packets flowing through measuring point 180 having ISP 130 as a destination (step 400). This set of identified addresses may be stored by flow identifier program 360 in source/destination address table 370 and may represent the flow of data through measuring point 180. The destination addresses in source/destination address table 370 may correspond to packets that originate from ISPs 110 and 140 whose originated packets terminate at ISP 130 via ISP 120. To determine the origin of the data packets, flow monitor 160 may send at least one destination address in source/destination address table 370 to flow monitor 150 through input/output interface 340.

Flow monitor 150 may receive the destination addresses through input/output interface 240 and may store these destination addresses in source/destination address table 270. Flow identifier program 260 may compare entries in source/destination address table 270 with destination addresses of data packets identified at measuring point 170 and flowing in a direction towards ISP 120 (step 410).

Flow monitor 260 may determine those data packets having destination addresses that match an entry in source/destination address table 270 (step 420). For each matching pair of destination addresses, flow identifier program 260 may identify the source address corresponding to the destination address identified at measuring point 170 (step 430). Flow identifier program 260 may then associate the source address identified at measuring point 170 and the matching destination address from source/destination address table 270 with a flow of data packets between measuring points 170 and 180 (step 440). Flow identifier program 260 then may use this flow information to create flow table 280-A, thus identifying data packets flowing from source ISP 110 to destination ISP 130.

During initialization of the system 190, flow monitor 150 may wait a predetermined period to create flow table 280-A. Once the initialization period is completed and flow table 280-A has been created, flow monitor 150 may send flow table 280-A to flow monitor 160 through input/output interface 240. Flow monitor 160 may then receive flow table 280-A through input/output interface 340 and store it as flow table 380-A, thus identifying data packets flowing from source ISP 110 to destination ISP 130. Flow identifier program 360 then may use flow table 380-A to identify data packets originating from ISP 110.

After the creation of flow table 380-A, flow monitor 160 may send an acknowledge message to flow monitor 150. The acknowledge signal may indicate that flow table 280-A and flow table 380-A are synchronized. The synchronization of these flow tables enables system 190 to take accurate SLA measurements.

During normal operations, flow database 280 at flow monitor 150 and flow database 380 at flow monitor 160 may be updated. Updates may occur when new addresses are added to the source/destination address table 370, or existing addresses are purged from the source/destination address table 370. Purging may take place when a data packet has not been observed within a predetermined time-out period. Once new addresses are added to source/destination address table 370, flow identifier program 260 may update flow database 280. Because it may take some time for the change in source/destination address table 370 to be incorporated into flow database 280, these updates may be performed such that updated flow database 280 and flow database 380 become effective at the same time.

For example, when source/destination address table 370 in flow monitor 160 is updated by flow identifier program 360 with a new destination address, source/destination address table 370 is sent to flow monitor 150 through input/output interface 340. Flow monitor 150 may receive at least one destination address stored in source/destination address table 370 through input/output interface 240 and store it in source/destination address table 270. Flow identifier program 260 may compare the destination addresses in source/destination address table 270 with destination addresses of data packets identified at measuring point 170. Flow identifier program 260 may determine those data packets flowing through measuring point 170 having destination addresses that match an entry in source/destination address table 270. For each matching pair of destination addresses, flow identifier program 260 may identify the source address corresponding to the destination address identified at measuring point 170. The source address identified at measuring point 170 and the matching destination addresses form a source-destination pair. Flow identifier program 260 associates the source-destination pair with the flow of data packets between measuring points 170 and 180.

Flow identifier program 260 may use this flow information to create flow table 280-A. Flow monitor 150 may send flow table 280-A to flow monitor 160 through input/output interface 240. Flow monitor 160 may receive flow table 280-A through input/output interface 240 and store it as flow table 380-A.

Flow identifier program 360 may use flow table 380-A to identify data packets originating from ISP 150. To ensure that the contents of flow tables 280-A and 380-A are identical, flow monitors 150 and 160 may communicate update messages within a predetermined time. Flow monitors 150 and 160 may also communicate source/destination address table 270 and 370 update messages and flow database 280 and 380 update messages, respectively, to synchronize use of the updated flow tables. These update messages may include information identifying the corresponding ISP; source/destination address table 270 and 370 sequence number field, indication of whether source/destination address table 270 and 370 include an initial table or an updated table, an update field for adding new IP address to the ISP network, and an update field for purging old IP addresses.

Source/destination address table 270 and 370 updates or flow database 280 and 380 updates may occur periodically at any predetermined time interval. The frequency of the updates may be arbitrary, provided flow monitors 150 and 160 use the same flow information.

To minimize the amount of data stored and communicated between flow monitors 150 and 160, source/destination address table 270 or 370 may be compressed by keeping track of the network addresses rather than the full host addresses that are determined from the identified destination addresses.

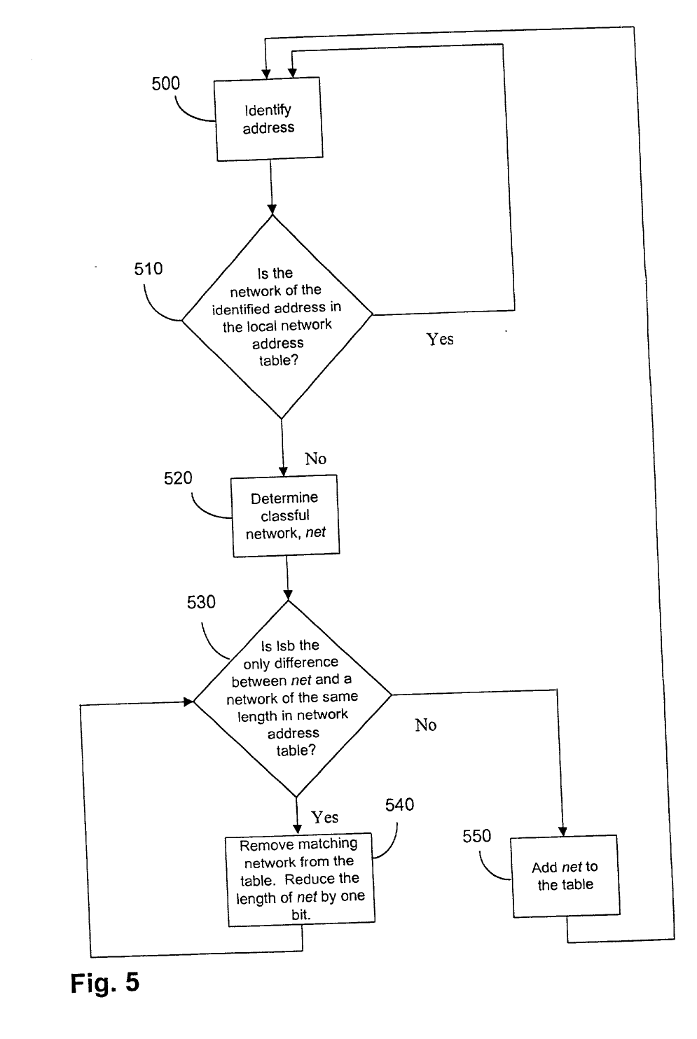

FIG. 5 is a flow chart of the steps performed by flow identifier program 360 for compressing the identified destination addresses in source/destination address table 370. This compression may include combining two independent compression methods. For example, compression may be performed using each method individually or in combination as will be described further below. Flow identifier program 360 may identify a destination address of each data packet to be monitored flowing through measuring point 180 having ISP 130 as a destination (step 500). Because core networks, such as ISP 120, route packets using network addresses, once the location of a particular destination is identified through its address, then the network corresponding to that particular destination may also be identified. The network address information may be stored in network address table 390 and transmitted in CIDR (Classless Inter-Domain Routing) format.

CIDR format identifies network address information as a prefix and a length. For example, consider network address 128.96/16 or 128.96.0.0/16. The terms 128.96 and 128.96.0.0 of the addresses correspond to prefixes. Whereas, the term 16 of both addresses correspond to the length of the network and the number of address bits. The first few bits of the prefix may identify a corresponding classful network. CIDR is a way to aggregate several classful networks so that routers can treat them as a single network. Because only the first few bits of the prefix may be used, network prefixes of varying length may be used to identify a wide range of classful networks. Classful networks identify a range of network address prefixes with a corresponding length. For example, an address for which the first bit is zero may be defined as a Class A network having a network length of 8.

Flow identifier program 360 may determine whether a network associated with the identified address exists in local network address table 395 (step 510). To make this determination, flow identifier program 360 may compare an identified destination address against other previously identified network addresses stored in network address table 390. If the identified destination address is not matched to an entry in network address table 390, then a classful network (net) is identified based on the first few bits of the destination address (step 520).

Once flow identifier program 360 determines net, a network address of length b, flow identifier program 360 may compare net with a network address stored in network address table 390 of the same length (step 530). If net and the network address of the same length differ only in their least significant bit, the matching network address may be removed from network address table 390 and the length of the net may be reduced by one bit to length b-1 (step 540). If the net and network address differ in more than their least significant bit, then flow identifier program 360 may add net to network address table 390 (step 550), thus, completing the compression operation. Assuming the net address and network address are merged, flow identifier program 360 may compare the merge result with the remaining networks in network address table 390 to determine whether additional merging is possible. When flow identifier program 360 performs all possible merges, i.e., net and network address differ in more than the least significant bit flow, flow identifier program 360 may add the merged network address, net, to network address table 390.

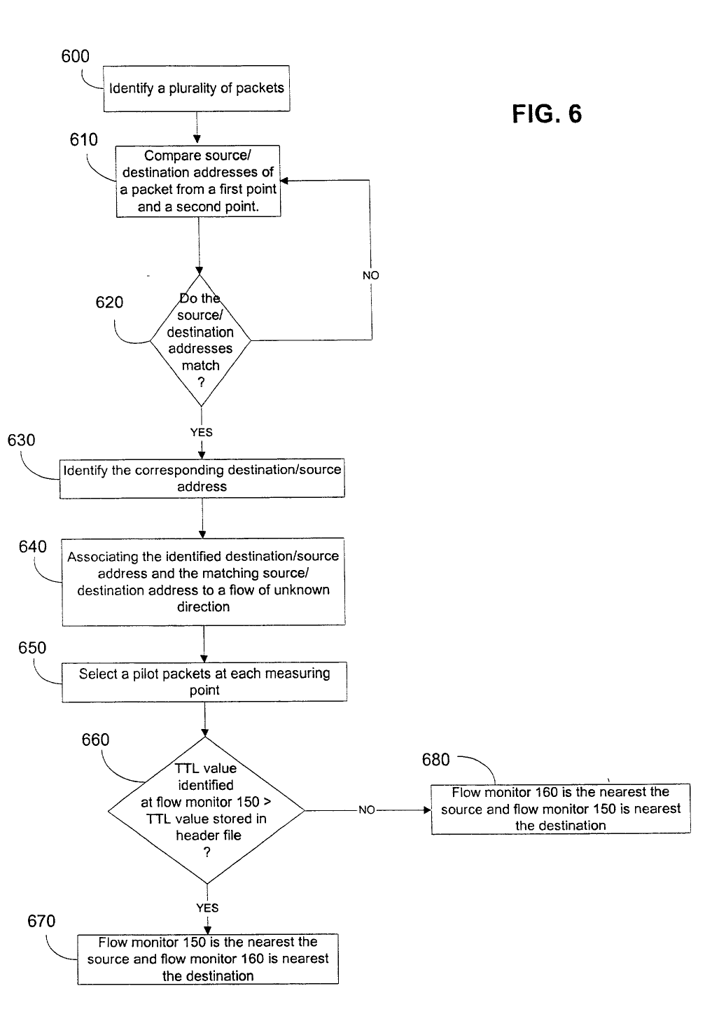

FIG. 6 is a flow chart of the steps performed by system 190 to determine the direction of data flow between measuring points 170 and 180, in accordance with an embodiment of the invention. In this embodiment, the physical medium may be a shared medium, such as an Ethernet. Since, in a shared medium, data packets may be flowing in opposite directions simultaneously on the same physical line, the direction of the flow of data packets between measuring points 170 and 180 may be unknown.

Flow identifier program 360 in flow monitor 160 may identify the addresses of data packets flowing through measuring point 180 and store the identified addresses in source/destination address table 370 (step 600). The addresses in source/destination address table 370 may correspond to more than just the packets that originate from ISP 110. Some of the identified destination addresses of packets that terminate at ISP 130 via ISP 120 may also originate from ISP 140.

To determine the origin of the identified data packets, flow monitor 160 may send at least one address stored in source/destination address table 370 to flow monitor 150 through input/output interface 340. Flow monitor 150 may receive and store the addresses in address table source/destination address table 270. Flow identifier program 260 may then compare the addresses stored in source/destination address table 270 with the addresses of data packets identified at measuring point 170 (step 610). Flow monitor 150 may determine those data packets flowing through measuring point 170 having addresses that match an entry in source/destination table 270 (step 620). For each matching pair of addresses, flow identifier program 260 may identify the corresponding destination/source address (step 630). The corresponding destination/source address identified at measuring point 170 and the matching address from source/destination address table 270 form a source-destination pair. Flow identifier program 260 may associate the source-destination pair with the flow of data packets between measuring points 170 and 180 (step 640). However, because the location of the source and destination of the data packets may still be unknown, flow identifier program 260 may use this flow information to create “unknown direction” table 280-B. Flow monitor 150 may send “unknown direction” table 280-B to flow monitor 160 where it is stored in flow database 380 as “unknown direction” table 380-B.

In determining the direction of the flow of data packets between monitoring points 170 and 180, flow identifier program 360 may select a packet (hereinafter referred to as a “pilot packet”) flowing through measuring point 180. The selected pilot packet may have a source and destination address that matches data stored in “unknown direction” table 380-B. The selected pilot-packet may have a one-to-many relationship with matching source-destination pairs stored in flow database 380. Flow identifier program 360 may store the header information of the pilot packet in header file 385. This header information may include a time-to-live (TTL) field, which is a field in the IP header of every data packet in the network. Routers (not shown) may connect any number of ISPs on a network. The TTL field of the pilot packet decrements by a value of one each time the pilot packet travels through a router. This property makes the TTL value asymmetrical between measuring points 170 and 180, allowing flow monitors 150 and 160 to determine the source of the data packets.

Flow monitor 160 may send the pilot packet header information stored in header file 385 to flow monitor 150. Flow monitor 150 may receive the header information and store it in “unknown direction” table 280-B of flow database 280. Flow identifier program 260 then selects a pilot packet flowing through measuring point 170 having source and destination addresses that match those of the identified flow stored in “unknown direction” table 280-B (step 650). Flow identifier program may store the header information of the selected pilot packet in header file 285 and compare the TTL value with the corresponding pilot packet header information stored in “unknown direction” table 280-B (step 660).

If the result of subtracting the time-to-live value selected at measuring point 170 from the time-to-live value stored in header file 285 is less than zero, then flow identifier program 260 may determine that ISP 110 is the source of the flow of data packets and ISP 130 is the destination (step 670). On the other hand, if the difference resulting from the same subtraction operation is greater than zero, then flow identifier program 260 may determine that ISP 130 is the source of the flow of data and ISP 110 is the destination (step 680). Assuming the subtraction result is less than zero, flow identifier program 260 may determine that flow database 280 identifies data packets flowing in a direction from source ISP 110 to destination ISP 130.

Once the direction of the data flow has been determined, the locations of the source and destination addresses (and thus the source and destination networks) are known. Flow identifier program 260 may determine the directions of other source-destination pairs that belong to the same network from either the source address or destination address just identified. Once flow identifier program 260 and 360 constructs network address tables 290 and 390 and local network address tables 295 and 395 by determining direction of data flow, the network address information may be used locally and may be propagated to other flow monitors serviced by ISP 120 for use in identifying the flow directions of other source-destination pairs. As packets are identified, flow monitors 150 and 160 may create various source/destination address tables so that locations of additional networks may be identified and more source-destination pairs may be added to the flow tables.

During initialization of system 190, flow monitor 150 may wait a pre-determined period to create a flow table in flow database 280, e.g., flow table 280-A. Once the initialization period is completed and flow table 280-A has been created, flow monitor 150 may send flow table 280-A to flow monitor 160 through input/output interface 340. Flow monitor 160 may receive the flow table 280-A through input/output interface 340 and store it as flow table 380-A. Flow monitor 150 may identify data packets originating from ISP 150 using flow table 380-A.

After the creation of flow table 380-A, flow monitor 160 may send an acknowledge message to flow monitor 150. The acknowledge signal may indicate that flow table 280-A and flow table 380-A are synchronized. The synchronization of these two flow tables enables system 190 to take accurate SLA measurements.

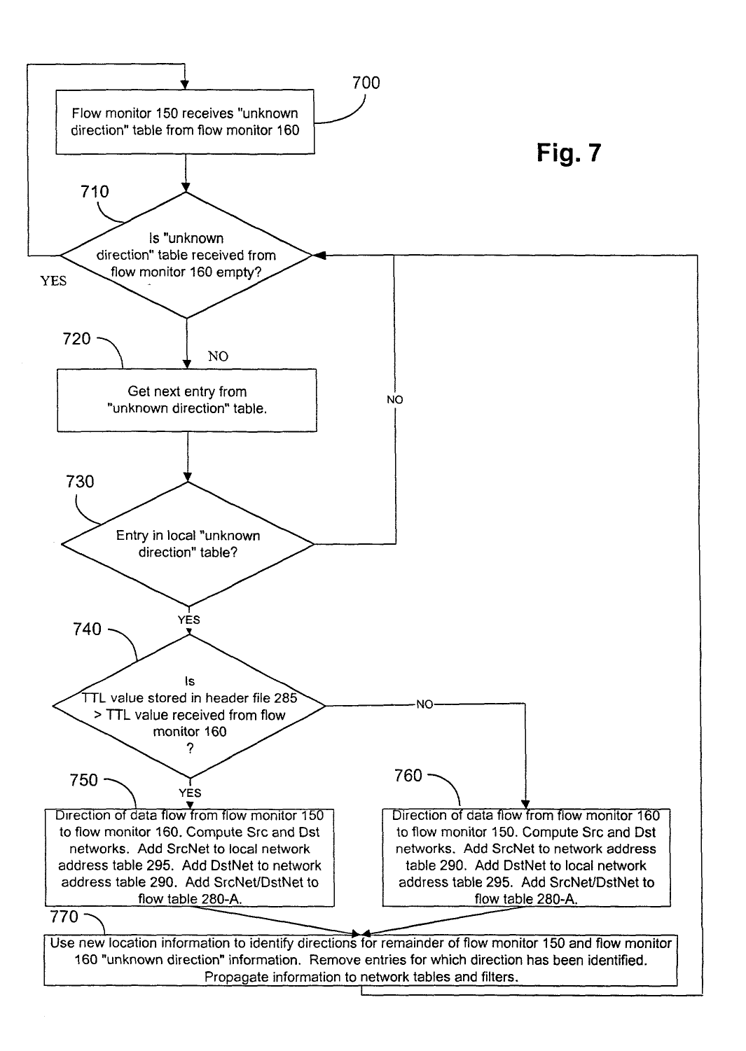

FIG. 7 is a flow chart of the steps performed by the flow monitors 150 and 160 to determine the directions of other source-destination pairs that belong to the same network. For example, once flow monitors 150 and 160 have identified a flow of data packets between measuring points 170 and 180 as illustrated in FIG. 4, flow monitor 150 may receive from flow monitor 160 “unknown direction” table 380-B stored in flow database 380. Flow monitor 150 may store received “unknown direction” table 380-B as “unknown direction” table 280-C in flow database 280 (step 700). Flow identifier program 260 may determine whether the “unknown direction” table 280-B includes flow information (step 710). If “unknown direction” table 280-B includes flow information then flow identifier program 260 may extract the next available entry (step 720). Otherwise, flow identifier program 260 may wait for the next “unknown direction” information from flow monitor 160.

Flow identifier program 260 may determine whether an entry in “unknown direction” table 280-C matches an entry in “unknown direction” table 280-B (step 730). If there is no match, then flow identifier program 260 may again determine whether “unknown direction” table 280-C includes flow information (step 710). Otherwise, flow identifier program 360 identifies a pilot packet associated with flow information stored in “unknown direction” table 380-B. Flow monitor 360 sends the pilot packet information to flow monitor 150, which may store the pilot packet header information in “unknown direction” table 280-C (step 740). Flow identifier program 260 may identify a pilot packet having a source and destination address matching the flow information stored in “unknown direction” table 280-B. Flow identifier program 260 may store this information in header file 285.

Flow identifier program 260 may then compare the header information stored in header file 285 with the header information stored in “unknown direction” table 280-C (step 750). If the TTL value stored in header file 285 is greater in value, then flow identifier program 260 may determine that the data packets flow in a direction from flow monitor 150 to flow monitor 160. As a result, flow identifier program 260 may store the source network address in local network address table 295 and the destination address in network address table 290, and may add the new flow information to flow table 280-A (step 760).

On the other hand, if the TTL value stored in “unknown direction” table 280-C is greater in value, then flow identifier program 260 may determine that the data packets flow in a direction from flow monitor 160 to flow monitor 150. As a result, flow identifier program 260 may store the source network address in network address table 290 and the destination address in local network address table 295, and may add the new flow information to flow table 280-A (step 770).

Flow identifier programs 260 and 360 may use the identified source and destination network information to determine the flow directions for other flows with an unknown direction. Once the direction of data flow has been identified, flow identifier programs 260 and 360 may remove address entries from the source/destination address tables 270 and 370 and unknown direction tables 280-C and 380-C. Accordingly, flow identifier programs 260 and 360 may add those same address entries to flow tables 280-A and 380-A. Further, flow identifier programs 260 and 360 may also place the address corresponding to the identified flow in source/destination address filters 280 and 380 and network address tables 290 and 390 (step 770). Moreover, once the flows have been identified, flow monitor 150 may send updated flow table 280-A to other flow monitor 160 for use in identifying the flow directions for any remaining “unknown direction” tables. Moreover, those entries in the “unknown direction” table 380-C for which the direction has been identified are removed and propagated to network address tables 390 and 395 and flow table 380-A as discussed above (step 780).

Flow monitors 150 and 160 may communicate a source/destination address table update message and a flow database update message to synchronize use of the updated flow tables. As discussed above, these update messages may include the information identifying the corresponding ISP, a source/destination table sequence number field, indication of whether the source/destination table is an initial table or an updated table, an update for adding new IP address to the ISP network, and an update field for purging old IP addresses.

The previous embodiments describe the identification of a flow of data and the determination of the direction of the flow with respect to identified destination addresses. However, identified source addresses may also be used to identify the flow and determine the direction as described below.

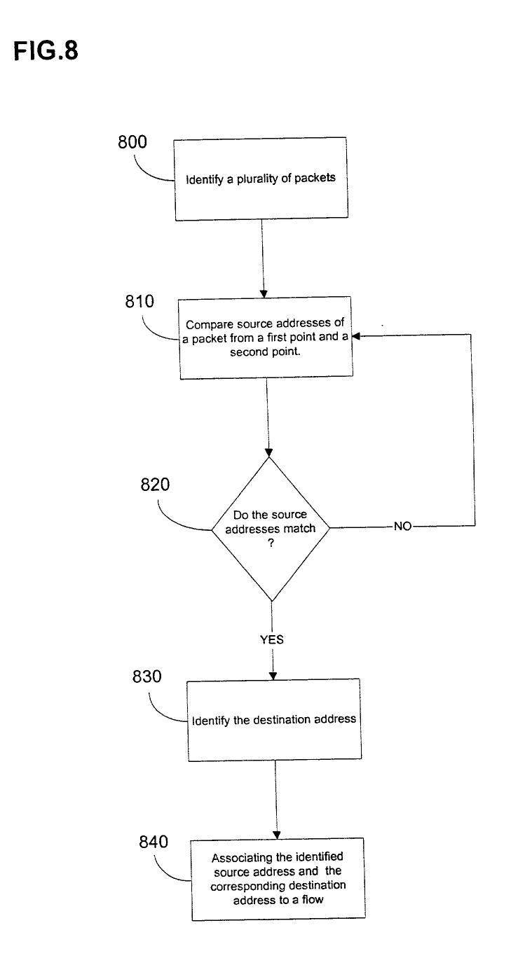

FIG. 8 is a flow chart of the steps performed for identifying the flow of data packets between measuring points 170 and 180, in accordance with another embodiment of the invention. In this embodiment, direction of the flow of data packets is assumed to originate at ISP 110 (source) and end at ISP 130 (destination).

Flow identifier program 260 in flow monitor 150 may identify the source addresses of data packets flowing through measuring point 170 having ISP 110 as a source (step 800). This set of identified source addresses may be stored in source/destination address table 270 and may represent the flow of data through measuring point 170. The source addresses in source/destination address table 270 may correspond to more than just the packets that are destined to ISP 130. Some of the identified source addresses may also be destined to ISP 140 or other ISPs (not shown) that happen to go through ISP 130 via ISP 120.

To determine the destination of data packets, flow monitor 150 may send at least one source address in source/destination address table 270 to flow monitor 160 through input/output interface 240. Flow monitor 160 may receive the source addresses through input/output interface 340 and store it as source/destination address table 370. Flow identifier program 360 may compare source addresses stored in source/destination address table 270 with source addresses of data packets identified at measuring point 180 and flowing in a direction toward ISP 130 (step 810).

Flow monitor 360 may determine those data packets having source addresses that match an entry in source/destination address table 370 (step 820). For each matching pair of source addresses, flow identifier program 360 may identify the destination address corresponding to the source address identified at measuring point 180 (step 830). Flow identifier program 360 may then associate the destination address identified at measuring point 180 and the matching source addresses from source/destination address table 270 with a flow of data packets between measuring points 170 and 180 (step 840). Flow identifier program 360 may use this flow information to create flow table 380-A. Flow table 380-A may identify data packets flowing from source ISP 110 to destination ISP 130.

While it has been illustrated and described what are at present considered embodiments and methods of the present invention, it will be understood by those skilled in the art that various changes and modifications may be made, and equivalents may be substituted for elements thereof without departing from the true scope of the invention.

In addition, many modifications may be made to adapt a particular element, technique, or implementation to the teachings of the present invention without departing from the central scope of the invention. Therefore, it is intended that this invention not be limited to the particular embodiments and methods disclosed therein, but that the invention include all embodiments falling within the scope of the appended claims.

What is claimed is:

1. A method for identifying a flow of data between a source and a destination in a network, said method comprising the steps of:
identifying a plurality of packets at a first point and a second point in the network;
comparing a source address of each packet identified at the second point with one or more source addresses of packets identified at the first point; and
if one of the compared source addresses matches, identifying a destination address of the corresponding packet identified at the second point, and associating the identified destination address and the matching source address to a flow between the source and destination.

2. A method for identifying a flow of data between a source and a destination in a network, said method comprising the steps of:
identifying a plurality of packets at a first point and a second point in the network;
comparing a destination address of each packet identified at the first point with one or more destination addresses of packets identified at the second point; and
if one of the compared destination addresses matches, identifying a source address of the corresponding packet identified at the first point, and associating the identified source address and the matching destination address to a flow between the source and destination.

3. The method of claim 2, wherein the step of identifying a plurality of packets at the second point further comprises the steps of:
generating a compressed address group based on the destination address of each packet identified at the second point.

4. The method of claim 3, wherein generating the compressed address group comprises:
identifying network addresses based on the destination addresses identified at the second point;
classifying each identified network address based on a range of bits in the identified network addresses.

5. The method of claim 3, wherein generating the compressed address group comprises:
identifying network addresses for the packets identified at the second point;
if the identified network addresses of two of the packets identified at the second point differ by a least significant bit, then generating a compressed address by combining the identified network addresses of the two packets.

6. The method of claim 3, wherein generating the compressed address group comprises:
identifying network addresses based on the destination address identified at the second point;
classifying each identified network address based on a range of bits in the identified network addresses; and
if the identified network addresses of two of the packets identified at the second point differ by a least significant bit, then generating a compressed address by combining the identified network addresses of the two packets, wherein the length of the compressed address is one bit less than the combined network addresses.

7. The method of claim 2, further comprising the step of:
generating flow information at the first point based on the matched destination address and the identified source address.

8. The method of claim 7, further comprising the step of:
sending the flow information generated at the first point to the second point.

9. The method of claim 8, further comprising:
updating the flow information at the first and second point when a new destination address is identified at the second point.

10. The method of claim 8, further comprising the step of:
updating the flow information at the first and second point when a destination address is purged at the second point after a predetermined time-out period.

11. A method for determining a direction of a flow of data between a source and a destination in a network, said method comprising the steps of:
identifying a plurality of packets at a first point and a second point in the network;
selecting a time-to-live value from the plurality of packets identified at the first point and at least one of the plurality of packets identified at the second point;
comparing a destination address of each packet identified at the first point with a destination address of one or more packets identified at the second point;
if one of the compared destination addresses matches, then identifying a source address of the corresponding packet identified at the first point, associating the identified source address and the matching destination address to a flow between the source and destination, and comparing the time-to-live value of the packets identified at the first point and the at least one of the plurality of packets identified at the second point corresponding to the flow between the source and the destination to determine the direction of the flow between the source and destination.

12. A method for determining a direction of a flow of data between a source and a destination in a network, said method comprising the steps of:
identifying a plurality of packets at a first point and a second point in the network;
selecting a time-to-live value from at least one of the plurality of packets identified at the first point and at least one of the plurality of packets identified at the second point;
comparing a source address of each packet identified at the second point with a source address of one or more packets identified at the first point;
if one of the compared source addresses matches, then identifying a destination address of the corresponding packet identified at the second point, and associating the identified destination address and the matching source address to a flow between the source and destination, and comparing the time-to-live value of the packets identified at the first point and the at least one of the plurality of packets identified at the second point corresponding to the flow between the source and the destination to determine the direction of the flow between the source and the destination.

13. A system for identifying a flow of data between a source and a destination in a network, comprising:
a first processor that identifies a destination address of one or more packets flowing through a second point in the network and sends the compressed destination addresses to a first point in the network; and
a second processor that identifies a destination address of a packet flowing through the first point, receives the destination addresses from the first processor, and generates flow information based on a comparison between the destination addresses received from the first processor and the destination addresses of the packet identified at the second processor, wherein the flow information identifies the flow of packets between the first point and the second point.

14. A system for identifying a flow of data between a source and a destination in a network, comprising:
a first processor that identifies a source address of one or more packets flowing through a first point in the network, and sends the source addresses to a second point in the network; and
a second processor that identifies a source address of a packet flowing through the second point, receives compressed source addresses from the first processor, and generates flow information based on a comparison between the source addresses received from the first processor and the source address of the packet identified at the second processor, wherein the flow information identifies the flow of packets between the first point and the second point.
